(19) United States
(12) Patent Application Publication
(10) Pub. No.: US 2003/0029075 A1
(43) Pub. Date: Feb. 13, 2003

(54) Live fish circle hook remover

(76) Inventor: William Leslie Hebard, Whitethorn, CA (US)

Correspondence Address: Hebard, William, Box 402, Whitethorn, CA, 95589, US

(21) Appl. No.: 10/139,813

(22) Filed: May 7, 2002

Related U.S. Application Data
(60) Provisional application No. 60/290,468, filed on May 11, 2001.

(51) Int. Cl. A01K 97/00

(52) U.S. Cl. 43/53.5

(57) ABSTRACT

This fish hook remover differs from other fish hook removers in that it turns the fish hook to a up side down position to be removed from even deep in a fishes throat. This tool does this by holding the eye of the fish hook while a trigger rod hooks the shank of the fish hook from the back side and roles it out of the hole it went in, to a upside down position.

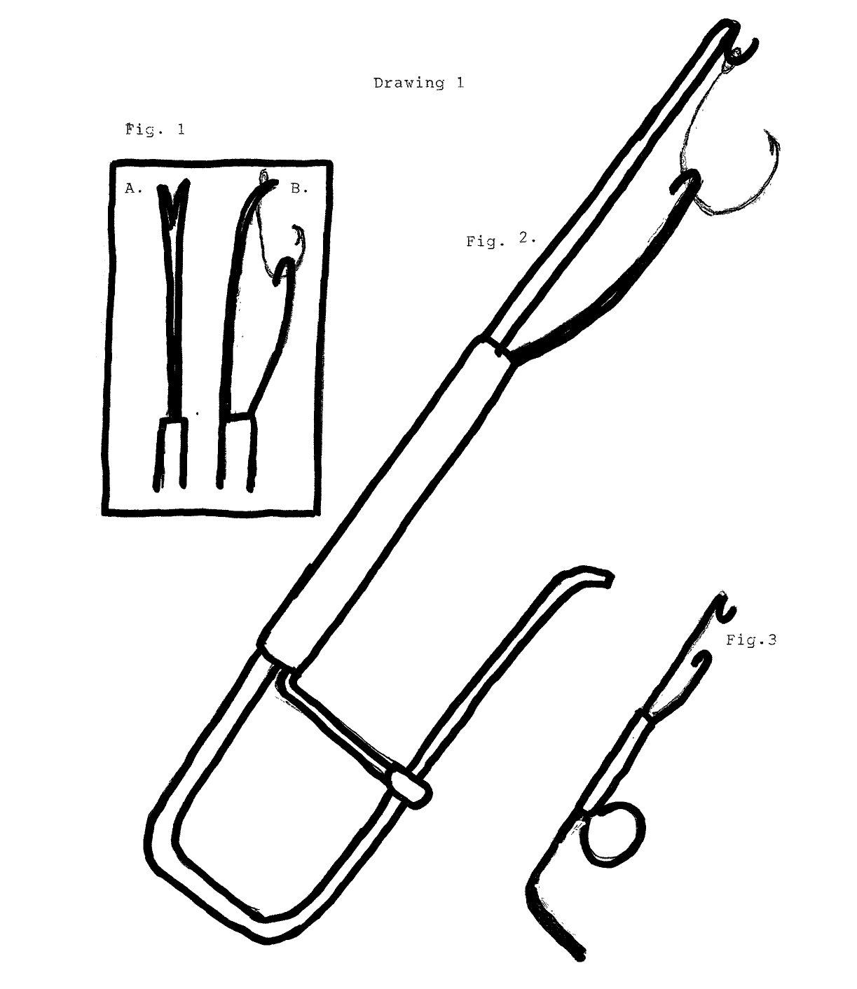

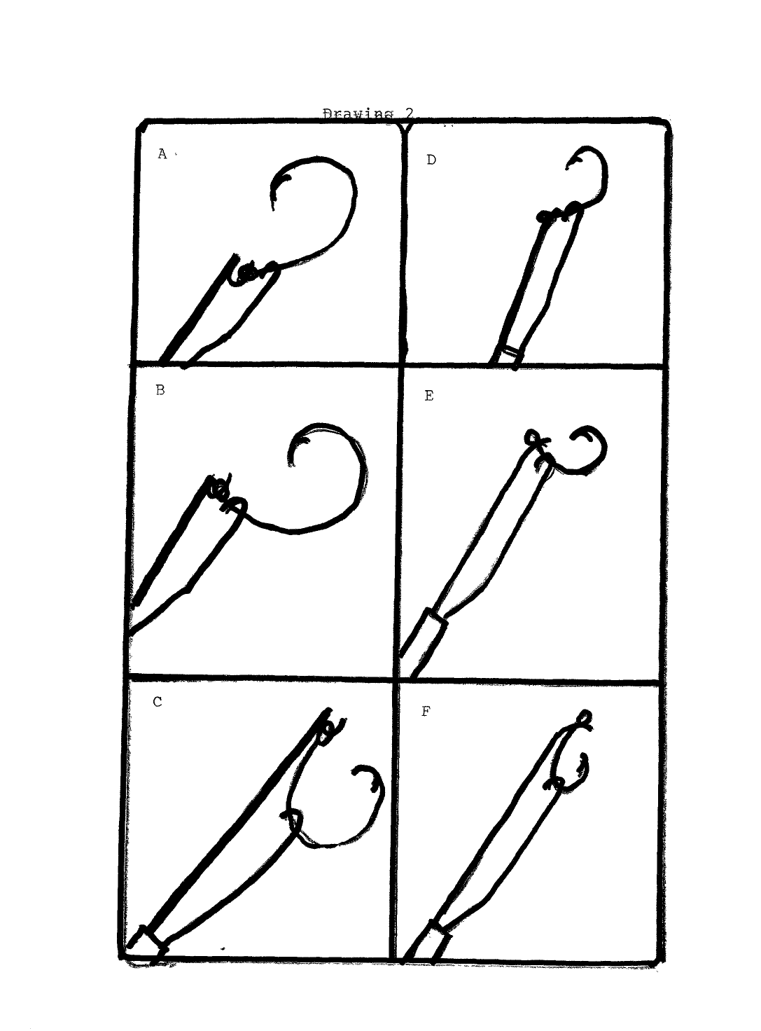

### INTRODUCTION

The idea of this fish hook remover is to allow a person to remove a hook from a deeply hooked fish to minimize damage to the fish and keeping the persons fingers clear from the teeth of the fish. Because this tool roles the hook out of the entry hole and turns the hook upside down the fish can be released without ever touching it. This greatly increases survival.

This tool also works very well on commercial salmon hooks and can be made to work with small sports hooks.

As a commercial fisherman I first thought of this tool about ten years ago to get a hook out of the gills of undersized salmon without hurting them any more then it is necessary, and it worked very well.

Now I am involved in live fishing which means keeping the fish alive for market. Since the prefered hook for live fishing gear is the circle hook and about the only way to get a circle hook out is to role it to a upside down postion which this tool does. So this tool has become a very important part of my fishing gear. Not only for keeping deeply hooked fish alive for me but also for keeping undersize and out of season fish alive. This tool is the best wayI have ever seen to get a hook out of the throat or gills of a lingcod without getting your hands in its teeth while decreasing damage to the fish. It also lets you unhook types of fish that have sharp plates on thier head without touching the head with either hand.

As I searched the current patents for similar tools I did find one that did have some similar moving parts although it worked by pushing the hook out in a upright position. This means you would almost always have to hold the fish and if the hook was in the throat it seems that it would be hard to use.

With my tool the hook is roled out and away from the entery to a upside dowm postion and can not hook again on th way out. Also if you can see the eye of the hook you can get it with my tool even if it is deep in the throat as long as the hook has room to role over. Also if you hold the fishes head out of the water by the line until it stops flopping long enough to grab the hook with the tool then pull the trigger and most of the time the fish will come right off unless it is hooked in a hard bone or plate if so lift the fish with the tool and its weight will pull it free.

### SPECIFICATIONS

This fish hook remover consists of two rods, one on top of the other horizontally, connected together with a matalic tube or sleeve. The top rod slides through the tube, the front end of this rod has a C shaped that holds through the eye of a large fish hook.(For small fish hooks this end is flattened and turned down with a deep V groove to hold the eye of the hook).The back end of the top rod is the handle and bends down then forword and is the guide for the bottom rod or trigger. The bottom rod is attached to the tube, with a hook at the front end that extends beyond the C shaped end of the top rod in open postion. The back end of the bottom rod bends down and loops around the guide end of the handle to form a sliding trigger. When the trigger is pulled back the hook end of the lower rod moves back behind the C end of the top rod. Different handles and triggers can be adapted but this one is very tough, simple and carefree for commericial use.

### Operating Description

To operate this tool the C shaped end of the top rod hooks through the eye of a large fish hook from the back side. (A V groove holds the eye for small fish hooks).The lower rod in forword position hooks the shank of the fish hook for the back side. When the bottom rod is moved back the hooked end slides to the bottom curve of the fish hook as the top pushes the eye of the fish hook down as it is turned upside down to come out easier with less damage to the fish.

1. To a fish hook remover that is constructed as to hold the eye of a fish hook at the tools forward extended point (by a c shaped hooked tip for large eyed fish hooks) (or a deep V groove for small eyed fish hooks). With a trigger that extends to a rod that is shaped to hook the shank of the fish hook and works by turning the fish hook to an up side down position to be removed.
